(19) United States
(12) Patent Application Publication
(10) Pub. No.: US 2017/0093030 A1
(43) Pub. Date: Mar. 30, 2017

(54) HELIX ANTENNA DEVICE

(71) Applicant: Getac Technology Corporation, Hsinchu County (TW)

(72) Inventors: Jia-Min HUANG, Taipei (TW); Yen-Ching LEE, Taipei (TW); Jui-Lin YANG, Taipei (TW)

(21) Appl. No.: 14/871,009

(22) Filed: Sep. 30, 2015

(51) Int. Cl. H01Q 1/36; H01Q 1/48

(52) U.S. Cl. CPC H01Q 1/362; H01Q 1/48

(57) ABSTRACT

A helix antenna device includes a board, a signal output circuit, a column body, a ground wire, and a helix antenna. The signal output circuit is disposed on the board. The column body includes a passage and a helix trough. A bottom surface of the column body is fastened to the board. The passage is along a central axis of the column body. The helix trough is formed around an annular side surface of the column body. The ground wire passes into the passage. One end of the ground wire is fastened to the board and is electrically connected to the signal output circuit. The helix antenna is around the column body. A part of the helix antenna is disposed in the helix trough. One end of the helix antenna is fastened to the board and is electrically connected to the signal output circuit.

### BACKGROUND OF THE INVENTION

Field of the Invention

The instant disclosure relates to an antenna and, more particularly, to a helix antenna device.

Description of the Prior Art

Some electronic devices, such as navigation devices, can be communicated to one another via satellites. The navigation devices utilize satellites positioning system, such as the global positioning system (GPS) or the global navigation satellite system (GNSS), for positioning and navigating. For example, a GPS electronic device utilizes the GPS for positioning and navigating. The communication of the GPS electronic device is based on GPS signals. The GPS signals are generated by 24 satellites on the orbits around the earth. The satellites broadcast the GPS signals toward the ground. A client with the GPS electronic device on the ground can use the GPS electronic device to receive the GPS signals from at least three satellites such that the position of the client can be calculated and derived. In order to achieve the wireless communication between the satellites and the GPS electronic device, the GPS electronic device is required to have an antenna for receiving and transmitting the GPS signals. The types of antennas are varied. In the realm of GPS applications, antennas of the GPS electronic devices can be patch antennas or helix antennas. In general, the bandwidths of patch antennas for receiving signals are relatively narrow, but the bandwidths of helix antennas are relatively wide. In light of receiving the GPS signals, helix antennas are better than patch antennas.

However, materials of helix antennas are usually soft. Shapes and structures of helix antennas are inherently easily deformed by external force. During the assembly process of the helix antennas and the electronic devices or the transportation process of the assembled electronic devices, the helix antennas are usually deformed by being pressed or impacted from external force. The structural parameters of the helix antenna such as the vertical separation or the pitch angle are changed when the structures of helix antenna are deformed. People having ordinary skill in the art shall understand that the quality of the signal reception and transmission will be influenced when the structural parameters of the helix antenna have some, even minor, changes.

In order to prevent the helix antennas from deformation by external force during the assembly process and the transportation process, operators on production lines and personnel for transportation are required to be very carefully to prevent the helix antennas from being pressed or impacted; therefore, the assembly process and the transportation process are inevitably required more time. Further, the costs of production and transportation are increased substantially.

The helix antenna is usually assembled to a board in advance, and then the assembled helix antenna with the board is assembled to certain electronic device. The process of having the helix antenna assembled to the board includes steps of positioning, assembling, and fastening. Each step is required to be accurate and without fault; otherwise, the qualities of the signal reception and transmission of final products will be influenced. As a result, operators on production lines need to spend a lot of time on the assembly process of the helix antennas and the boards.

To resolve the above issue, it is desperate to people in the art to find solutions regarding that the helix antennas can be conveniently assembled to the boards and are hard to be deformed by external force so as to avoid influence of the structural parameters of the helix antennas.

### SUMMARY OF THE INVENTION

According to aforementioned description, the present invention provides a helix antenna device. It is convenient and accurate to have a helix antenna assembled to a board, and the structure of the helix antenna is hard to be deformed so that the structural parameters of the helix antenna can be maintained.

An embodiment of the present invention provides a helix antenna device comprising a board, a signal output circuit, a column body, a ground wire, and a helix antenna. The signal output circuit is disposed on the board. The column body comprises a passage and a helix trough. A bottom surface of the column body is fastened to the board. The passage is along a central axis of the column body. The helix trough is formed around an annular side surface of the column body. The ground wire passes into the passage. One end of the ground wire is fastened to the board and is electrically connected to the signal output circuit. The helix antenna is around the column body. At least a part of the helix antenna is disposed in the helix trough. One end of the helix antenna is fastened to the board and is electrically connected to the signal output circuit.

According to some embodiments, the board comprises a first hole and a second hole. One end of the ground wire is fastened to the first hole, and one end of the helix antenna is fastened to the second hole.

According to some embodiments, the board further comprises at least a third hole, and the column body further comprises at least a fastening element. The fastening element protrudes from the bottom surface of the column body. The fastening element is capable of being fastened to the third hole.

According to some embodiments, the first hole, the second hole, and the third hole are aligned along a direction and are arranged in spaced relationship.

According to some embodiments, the board further comprises a first surface and a second surface opposite to the first surface. The bottom surface of the column body is at the first surface. The fastening element comprises an extending portion and a hook portion. The hook portion is against the second surface when the extending portion passes into the third hole.

According to some embodiments, the number of the fastening element is two. The two fastening elements are symmetrical. The number of the third hole is two. The two third holes are respectively corresponding to the two fastening elements. The hook portions of the two fastening elements extend away from each other.

According to some embodiments, the column body has a shape of circular column and the column body comprises a polymer.

According to some embodiments, the column body and the ground wire are perpendicular to the board.

According to some embodiments, one end of the helix antenna is perpendicular to and is fastened to the board, and the other end of the helix antenna has a cross section defining a normal vector parallel with a tangent vector tangent to the annular side surface of the column body.

Concisely, the helix antenna of the helix antenna device of the embodiments of the present invention is disposed on the column body, and then the helix antenna is assembled to the board via the column body. The assembly process of the helix antenna is convenient and accurate. The assembled helix antenna is supported by the column body; therefore, the shape and the structure of the helix antenna are hard to be deformed so as to ensure that the structural parameters of the helix antenna can be maintained.

The features of the present invention will no doubt become understandable to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of a helix antenna device according to an embodiment of the present invention;

FIG. 2 illustrates a perspective view of the helix antenna device, rotated 180 degrees from the view of FIG. 1;

FIG. 3 illustrates an exploded view of the helix antenna device of FIG. 1;

FIG. 4 illustrates a perspective view of an aspect of a helix antenna, a ground wire, and a column body of FIG. 1; FIG. 5 illustrates a side view of the helix antenna, the ground wire, and the column body of FIG. 4;

FIG. 6 illustrates a cross-sectional view taken along line 6-6 of FIG. 5; and

FIG. 7 illustrates a block diagram of the helix antenna device of FIG. 1.

### DETAILED DESCRIPTION OF THE EMBODIMENTS

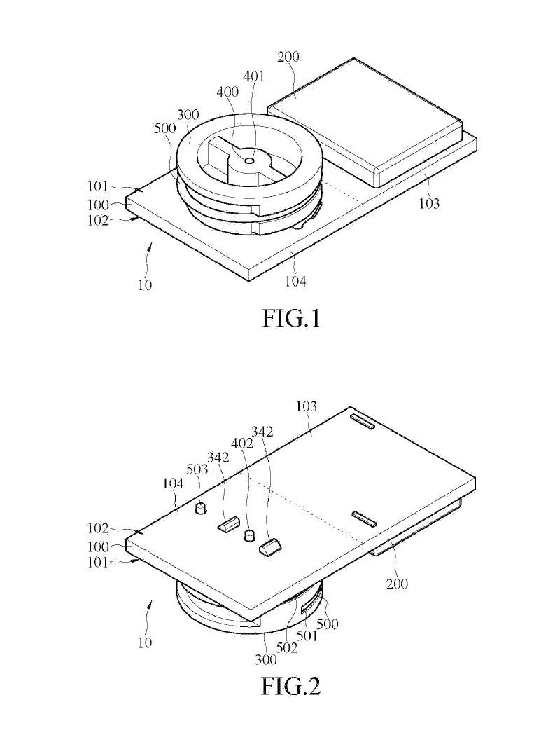

Referring to FIG. 1 and FIG. 2, FIG. 1 illustrates a perspective view of a helix antenna device 10 according to an embodiment of the present invention, and FIG. 2 illustrates a perspective view of the helix antenna device 10, rotated 180 degrees from the view of FIG. 1. In an embodiment, the helix antenna device 10 can be assembled to certain electronic device (e.g., a portable device or a vehicle navigation device) to receive radio frequency signals (e.g., GPS signals).

The helix antenna device 10 comprises a board 100, a signal output circuit 200, a column body 300, a ground wire 400, and a helix antenna 500. The board 100 comprises a first surface 101 and a second surface 102, and a first area 103 and a fourth area 104. The first surface 101 and the second surface 102 are opposite to each other. The first area 103 and the fourth area 104 are near to each other. In the embodiment, a part of the board 100 (i.e., the right part relative to the dashed line of FIG. 1 and FIG. 2) is the first area 103, and the other part of the board 100 (i.e., the left part relative to the dashed line of FIG. 1 and FIG. 2) is the fourth area 104.

The signal output circuit 200 is disposed on the first surface 101 of the first area 103 of the board 100. The column body 300 is fastened to the board 100. The column body 300 is at the second area 104 of the board 100. The ground wire 400 and the helix antenna 500 are disposed on the column body 300. Moreover, the ground wire 400 and the helix antenna 500 are electrically connected to the signal output circuit 200.

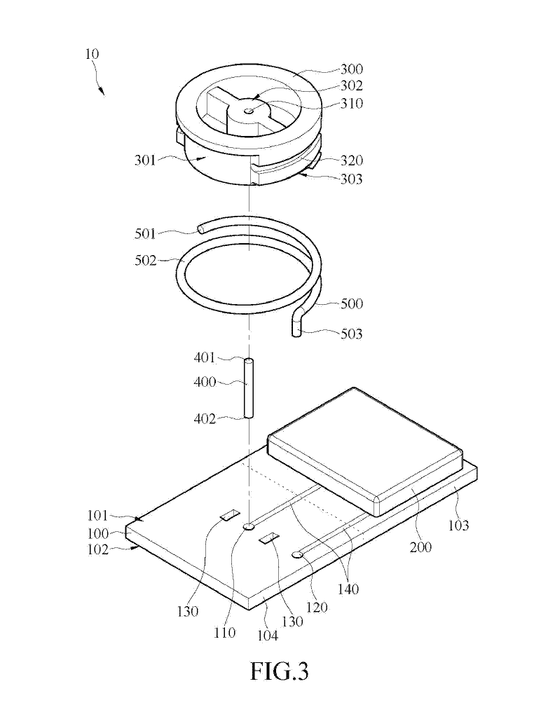

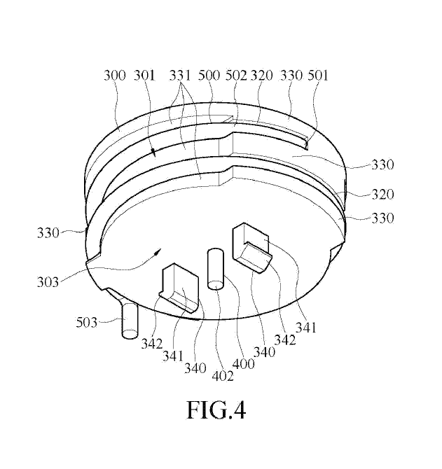

Referring to FIG. 3, FIG. 4, and FIG. 5, FIG. 3 illustrates an exploded view of the helix antenna device 10 of FIG. 1, FIG. 4 illustrates a perspective view of an aspect of the helix antenna 500, the ground wire 400, and the column body 300 of FIG. 1, and FIG. 5 illustrates a side view the helix antenna 500, the ground wire 400, and the column body 300 of FIG. 4. The column body 300 comprises a passage 310 and a helix trough 320. In the embodiment, the column body 300 has a shape of circular column. An annular side surface 301 of the column body 300 is coaxial with a central axis of the column body 300 and is around the side of the column body 300. A top surface 302 and a bottom surface 303 of the column body 300 are respectively at two opposite ends of the column body 300 along the central axis thereof. The bottom surface 303 of the column body 300 is fastened to the board 100. The bottom surface 303 is on the first surface 101 of the board 100. The passage 310 is formed along the central axis of the column body 300. The passage 310 penetrates trough the column body 300 from the top surface 302 to the bottom surface 303. The helix trough 320 is formed around the annular side surface 301 of the column body 300. In the embodiment, the column body 300 comprises a polymer. For example, the column body 300 can be produced by injection molding of plastic materials.

The ground wire 400 has a line shaped structure. The ground wire 400 has a top segment 401 and a bottom segment 402. The bottom segment 402 is at one end of the ground wire 400, and the top segment 401 is at the other end of the ground wire 400 opposite to the bottom segment 402. The ground wire 400 passes into the passage 310. The top segment 401 is inside the passage 310. In the embodiment, the end of the top segment 401 of the ground wire 400 is, but is not limited to, aligned with the top surface 302 of the column body 300. The bottom segment 402 extends outside the bottom surface 303 of the column body 300; therefore, the bottom segment 402 stays outside the column body 300 but not in the passage 310. Moreover, the bottom segment 402 is fastened to the board 100. The column body 300 and the ground wire 400 are perpendicular to the board 100. In particular, the central axis of the column body 300 is perpendicular to the first surface 101 and the second surface 102 of the board 100. An extending direction of the ground wire 400 from the top segment 401 to the bottom segment 402 is also perpendicular to the first surface 101 and the second surface 102 of the board 100.

The helix antenna 500 may be a helical structure. The helix antenna 500 has a top segment 501, a body 502, and a bottom segment 503. The bottom segment 503 is at one end of the helix antenna 500, and the top segment 501 is at the other end of the helix antenna 500. The body 502 is between the top segment 501 and the bottom segment 503. The helix antenna 500 is around the column body 300 and at least a part of the helix antenna 500 is disposed in the helix trough 320. In particular, the body 502 has a helical structure and is around the annular side surface 301 of the column body 300. The top segment 501 is away from the board 100 with respect to the bottom segment 503. The bottom segment 503 is bended and extends toward the board 100; therefore, the bottom segment 503 is parallel with the ground wire 400 and the central axis of the column body 300. The bottom segment 503 is fastened to the board 100.

The ground wire 400 is inserted into the passage 310 of the column body 300 along the central axis of the column body 300. The helix antenna 500 is helically winded to be assembled to the column body 300. The assembly process of the helix antenna 500 and the column body 300 includes: firstly aligning the helix antenna 500 with the central axis of the column body 300; secondly aligning the top segment 501 with an opening of the helix trough 320 close to the bottom surface 303 of the column body 300; next rotating the helix antenna 500 along the helix trough 320 to have the helix antenna 500 closed to the column body 300 along the central axis; finally having the top segment 501 and the body 502 be around the annular side surface 301 of the column body 300. The bottom segment 503 could be bended before the assembly of the helix antenna 500 and the column body 300; alternatively, the bottom segment 503 could be bended after the helix antenna 500 has been assembled to the column body 300. In other embodiments, the ground wire 400, the helix antenna 500, and the column body 300 can be produced by insert molding. The fastening effect between the ground wire 400, the helix antenna 500, and the column body 300 can be enhanced under the circumstance that these elements are produced by insert molding.

In the embodiment, the column body 300 further comprises a plurality of flanges 330. The flanges 330 are around the annular side surface 301 of the column body 300 and are arranged in spaced relationship. The flanges 330 are used to form the helix trough 320. In particular, the intervals between two adjacent flanges 330 along a direction parallel with the central axis of the column body 300 form the helix trough 320. In addition, the flanges 330 are arranged in spaced relationship but are not continuously around the annular side surface 301. In other words, the flanges 330 do not form a complete helical structure on the annular side surface 301. On the contrary, the helical structure formed by the flanges 330 around the annular side surface 301 is non-continuous. As a result, there are notches 331 formed between the spaced flanges 330 along the helical structure. The notches 331 between the flanges 330 do not substantially form the helix trough 320. In other words, each of two adjacent flanges 330 along the direction parallel with the central axis of the column body 300 forms a part of the helix trough 320; therefore, the helix trough 320 formed by the flanges 330 do not have a complete helical structure. As a result, a part of the body 502 is disposed in the helix trough 320, and the other part of the body 502 is located at the notches 331. The flanges 330 support the helix antenna 500 well to maintain the shape and the structure of the helix antenna 500 even though the flanges 330 merely form a part of the helix trough 320. In other embodiments, the flanges 330 can be continuously around the annular side surface 301 without any notches 331 therebetween; therefore, the body 502 is completely disposed in the helix trough 320 under the circumstance that the helix trough 320 formed by the flanges 330 has a complete helical structure. As a result, the flanges 330 support the helix antenna 500 better to maintain the shape and the structure of the helix antenna 500.

In some embodiments, the board 100 comprises a first hole 110 and a second hole 120. The first hole 110 is corresponding to the ground wire 400. The second hole 120 is corresponding to the helix antenna 500. The bottom segment 402 at one end of the ground wire 400 is fastened to the first hole 110. The bottom segment 503 at one end of the helix antenna 500 is fastened to the second hole 120.

In some embodiments, the board 100 comprises two board circuits 140. The two board circuits 140 are disposed on the first surface 101. One of the two board circuits 140 is electrically connected between an inner wall (not shown) of the first hole 110 and the signal output circuit 200, and, analogously, the other board circuit 140 is electrically connected between an inner wall (not shown) of the second hole 120 and the signal output circuit 200. In particular, the bottom segment 402 of the ground wire 400 and the bottom segment 503 of the helix antenna 500 are respectively electrically connected to the inner walls of the first hole 110 and the second hole 120, and are electrically connected to the signal output circuit 200 via the board circuits 140. In other embodiments, the board circuits 140 can be disposed inside the board 100 or can be disposed on the second surface 102 of the board 100.

In some embodiments, the board 100 further comprises at least a third hole 130 in addition to the first hole 110 and the second hole 120. For the convenience of description, an example that two third holes 130 are provided is described below. As shown in FIG. 4, the column body 300 further comprises two fastening elements 340 protruding from the bottom surface 303 of the column body 300. The two fastening elements 340 are symmetrical. The two third holes 130 are respectively corresponding to the two fastening elements 340. The two fastening elements 340 are capable of being respectively fastened to the two third holes 130. In other embodiments, the number of the fastening element 340 can be one or can be greater than two, and, accordingly, the number of the third hole 130, corresponding to the fastening element 340, can be one or can be greater than two. In the embodiment, the first hole 110, the second hole 120, and the third holes 130 are aligned along a direction and are arranged in spaced relationship. In other embodiments, the first hole 110, the second hole 120, and the third holes 130 are disposed separately.

In the embodiment, the fastening element 340 comprises an extending portion 341 and a hook portion 342. The extending portion 341 has a shape of rectangular column. The hook portion 342 has a shape of triangular column. One end of the extending portion 341 is connected to the hook portion 342, and the other end of the extending portion 341 is connected to the bottom surface 303 of the column body 300. The two hook portions 342 of the two fastening elements 340 extend away from each other. After the extending portion 341 passes into the third hole 130, the bottom surface 303 of the column body 300 is against the first surface 101 of the second area 104 of the board 100, and the hook portion 342 is against the second surface 102 of the second area 104 of the board 100.

The helix antenna 500, the ground wire 400, and the column body 300 can be easily and accurately assembled to the board 100 by the use of the first hole 110, the second hole 120, and the third hole 130. During assembly, firstly assembly personnel can have the bottom segment 402, the bottom segment 503, and the fastening element 340 respectively aligned with the first hole 110, the second hole 120, and the third hole 130, and, secondly, assembly personnel can slightly force the column body 300 to move toward the board 100 along the central axis of the column body 300. Assembly personnel can fix the board 100 by jigs before forcing the column body 300 toward the board 100; alternatively, assembly personnel can respectively hold the board 100 and the column body 300, and force them toward each other. When the interval between the column body 300 and the board 100 decreases, the bottom segment 402 passes into the first hole 110, the bottom segment 503 passes into the second hole 120, and the fastening elements 340 pass into the third holes 130. Meanwhile, the two fastening elements 340 are restricted by inner walls of the two third holes 130 such that the two hook portions 342 are against the inner walls of the third holes 130. The walls apply reaction force on the two hook portions 342 such that the two hook portions 342 are moved toward each other; accordingly, the two hook portions 342 cause the two extending portions 341 elastically deformed. Next assembly personnel keep forcing the column body 300 and the board 100 to move toward each other until the two hook portions 342 completely pass through the two third holes 130. Thereafter, the two hook portions 342 do not restricted by inner walls of the two third holes 130 anymore. Accordingly, the fastening portions 341 are restored to the original shape (i.e., the shape before the elastic deformation) by resilience, which makes the two hook portions 342 moved away from each other and returned to their original positions. Under the circumstance, the hook portions 342 are against the second surface 102 of the board 100, and the bottom surface 303 of the column body 300 are against the first surface 101 of the board 100; therefore, the board 100 is sandwiched between the bottom surface 303 of the column body 300 and the hook portions 342. In other words, the relative position of the column body 300 and the board 100 can be maintained by the cooperation of the bottom surface 303 of the column body 300 and the hook portions 342.

When the fastening element 340 passes the third holes 130, the bottom segment 402 of the ground wire 400 and the bottom segment 503 of the helix antenna 500 respectively pass the first hole 110 and the second hole 120. The bottom segment 402 and the bottom segment 503 extend slightly outside the second surface 102 of the board 100 after the hook portions 342 completely pass through the third holes 130. Next assembly personnel can weld the first hole 110 through which the bottom segment 402 passes and the second hole 120 through which the bottom segment 503 passes to have the bottom segment 402 and the bottom segment 503 connected to the board circuits 140. After welding, not only the ground wire 400 and the helix antenna 500 can be respectively electrically connected to the signal output circuit 200, but also the connection between the ground wire 400, the helix antenna 500, the column body 300, and the board 100 can be more stable.

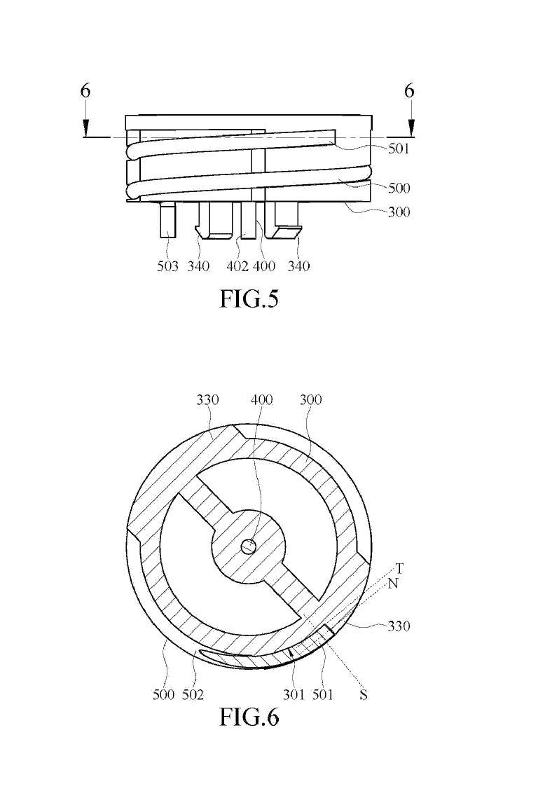

Referring to FIG. 6, FIG. 6 illustrates a cross-sectional view taken along line 6-6 of FIG. 5. In the embodiment, the top segment 501 of the helix antenna 500 is aligned with the annular side surface 301 of the column body 300. In particular, the top segment 501 has a cross section taken along a virtual plane S and defining a normal vector N. There is a tangent vector T tangent to the annular side surface 301 of the column body 300 at an intersection of the annular side surface 301 and the virtual plane S. The normal vector N is parallel with the tangent vector T. In other words, the top segment 501 and the body 502 mutually form a helical structure. The helix antenna device 10 of the embodiment can generate a more circular radiation pattern or a more omnidirectional radiation pattern to increase the ability to receive signals of electromagnetic waves in all directions.

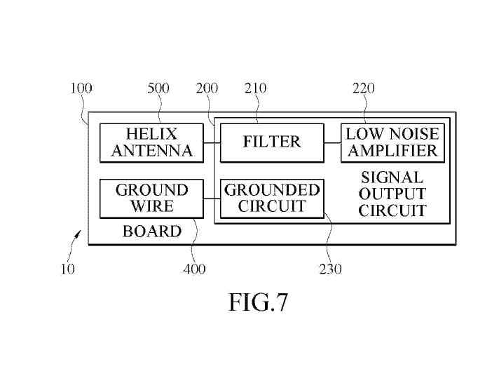

Referring to FIG. 7, FIG. 7 illustrates a block diagram of the helix antenna device of FIG. 1. The signal output circuit 200 comprises a filter 210, a low noise amplifier 220, and a grounded circuit 230. The helix antenna 500 is electrically connected to the filter 210. The filter 210 is electrically connected to the low noise amplifier 220. The ground wire 400 is electrically connected to the grounded circuit 230. In the embodiment, the helix antenna device 10 is used for receiving circular polarized signals. The helix antenna 500 is used for being a signal feeding route, and the ground wire 400 is grounded. The cooperation of the helix antenna 500 and the ground wire 400 is capable of receiving signals with particular frequencies. For example, the helix antenna device 10 is capable of receiving the GPS signals based on particular structural parameters such as the vertical separation and the pitch angle of the helix antenna 500 and the radius of a turn on the helix antenna 500 between the helix antenna 500 and the ground wire 400. Moreover, the ground wire 400 is disposed in the helix antenna 500 (i.e., the ground wire 400 is disposed alone the central axis of the helix antenna 500), and signals are fed in through the bottom segment 503 of the helix antenna 500; therefore, the magnetic flux in the helix antenna 500 can be increased such that the helix antenna device 10 is good at receiving the GPS signals in all direction.

Concisely, the embodiment of the present invention provides the helix antenna device. The ground wire and the helix antenna of the helix antenna device are disposed on the column body and are respectively corresponding to the first hole and the second hole of the board. The fastening element of the column body is corresponding to the third hole of the board. The column body is assembled to the board by the fastening element. Meanwhile, the ground wire and the helix antenna pass into the first hole and the second hole. After the aforementioned process, assembly personnel just need to weld the first hole and the second hole, and then the assembly of the helix antenna device is done. The assembly method is convenient and accurate. The helix antenna of the embodiment of the present invention is supported by the column body; therefore, the shape and the structure of the helix antenna are hard to be deformed by being pressed. The helix trough is capable of maintaining the vertical separation and the pitch angle of the helix antenna so as to ensure that the structural parameters are not easily influenced by external force.

While the present invention has been described by way of example and in terms of the preferred embodiments, it is to be understood that the present invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A helix antenna device, comprising:
a board;
a signal output circuit disposed on the board;
a column body comprising a passage and a helix trough, a bottom surface of the column body being fastened to the board, the passage being along a central axis of the column body, the helix trough being formed around an annular side surface of the column body;
a ground wire passing into the passage, one end of the ground wire being fastened to the board and being electrically connected to the signal output circuit; and
a helix antenna around the column body, at least a part of the helix antenna being disposed in the helix trough, one end of the helix antenna being fastened to the board and being electrically connected to the signal output circuit.

2. The helix antenna device of claim 1, wherein the board comprises a first hole and a second hole, one end of the ground wire is fastened to the first hole, and one end of the helix antenna is fastened to the second hole.

3. The helix antenna device of claim 2, wherein the board further comprises at least a third hole, the column body further comprises at least a fastening element, the at least a fastening element protrudes from the bottom surface of the column body, and the at least a fastening element is capable of being fastened to the at least a third hole.

4. The helix antenna device of claim 3, wherein the first hole, the second hole, and the at least a third hole are aligned along a direction and are arranged in spaced relationship.

5. The helix antenna device of claim 3, wherein the board further comprises a first surface and a second surface opposite to the first surface, the bottom surface of the column body is at the first surface, the at least a fastening element comprises an extending portion and a hook portion, and the hook portion is against the second surface when the extending portion passes into the at least a third hole.

6. The helix antenna device of claim 5, wherein the number of the at least a fastening element is two, the two fastening elements are symmetrical, the number of the at least a third hole is two, the two third holes are respectively corresponding to the two fastening elements, and the hook portions of the two fastening elements extend away from each other.

7. The helix antenna device of claim 1, wherein the column body has a shape of circular column and the column body comprises a polymer.

8. The helix antenna device of claim 1, wherein the column body and the ground wire are perpendicular to the board.

9. The helix antenna device of claim 1, wherein one end of the helix antenna is perpendicular to and is fastened to the board, and the other end of the helix antenna has a cross section defining a normal vector parallel with a tangent vector tangent to the annular side surface of the column body.
